(19) United States
(12) Patent Application Publication
(10) Pub. No.: US 2009/0309854 A1
(43) Pub. Date: Dec. 17, 2009

(54) INPUT DEVICES WITH MULTIPLE OPERATING MODES

(75) Inventors: Peter W. Hildebrandt, Duluth, GA (US); James Watson, (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: Polyvision Corporation, Suwannee, GA (US)

(21) Appl. No.: 12/138,933

(22) Filed: Jun. 13, 2008

(51) Int. Cl. G06F 3/033

(52) U.S. Cl. 345/179

(57) ABSTRACT

An input device for interacting with a display surface of an electronic display system. The input device can comprise a body, a nib, a sensing system, a cap, and a mode-indicating system. The body can provide structural support for the input device. The nib, which is in communication with the body, can be used to directly interact with the display surface. The sensing system can sense indicia of a posture of the input device with respect to the display surface to facilitate operation of the input device. The cap is securable over the nib, and can be incorporated into the mode-indicating system. When the cap is secured over the nib, the input device can operate in a first operating mode, and when the cap is removed, the input device can operate in a second operating mode.

### BACKGROUND

Various aspects of the present invention relate to electronic display systems and, moreover, to input devices for electronic display systems.

It is known to digitize handwriting on a surface, such as a piece of paper, by determining how a pen is moved. A position-coding pattern for coding coordinates of points can be provided on the surface. The pen can be provided with a sensor for recording the position-coding pattern locally at the tip of the pen as the pen contacts the surface. For example, a processing unit, which can be disposed within the pen or at a distance therefrom, can decode the recorded position-coding pattern by analyzing the portion of the pattern viewed by the camera. As a result, movement of the pen across the surface can be determined as a series of coordinates.

For example, there exists a method of determining coordinates from a dot matrix position-coding pattern, or dot pattern, on a piece of paper. Each set of six-by-six dots accurately defines a single coordinate. A pen containing a camera can view the dots and, thereby, calculate a coordinate at which the pen is positioned. For example, International Patent Publication No. WO 01/26032 to Pettersson and U.S. Pat. No. 7,249,716 to Bryborn describe such dot patterns.

Conventional electronic whiteboard systems provide electronic pens and styli for marking on a whiteboard surface. A stylus may perform as a drawing, writing, or pointing device, and can include a camera for viewing a position-coding pattern, such as a known image. Conventional electronic whiteboard systems do not, however, implement dot matrix position-coding patterns. The stylus of such a system may also include a cap, which can be used to protect the stylus, and to activate or deactivate the stylus. Further, function buttons have been implemented for alternating between various functions of the stylus.

U.S. Patent Application Publication No. 2007/0003168 to Oliver discloses use of a cap to alternate between focal lengths of the included camera, where placement of the cap over the tip of the stylus results in the camera having a different focal length than when the cap is removed. Oliver does not, however, disclose use of the stylus as a pointing device, or use of the camera to view a dot matrix position-coding pattern.

### SUMMARY

There is a need in the art for an improved input device, such as a stylus or pen, for an electronic display system, such as an electronic whiteboard system. Preferably, such an improved input device can alternate operating modes based on a state of the input device.

Briefly described, various embodiments of the present invention include an input device for an electronic display system having an electronic display surface. The input device indicates an area of the display surface upon which to be operated, and can also indicate the mode of operation. The input device comprises a body, a nib, a sensing system, and a mode-indicating system.

The body provides structural support for the input device, and can also provide housing and protection for inner components of the input device.

The nib is in communication with the body. The nib is analogous to the tip of a conventional pen. Accordingly, the nib can contact and mark the display surface and, thereby, perform as a conventional marking device.

In one embodiment, the mode-indicating system can include a cap for the input device. The input device can operate in a first operating mode when the cap is secured over the nib, and in a second operating mode when the cap is not secured over the nib. The first operating mode can comprise a marking mode, in which the input device can mark the display surface. The second operating mode can comprise a pointing mode, in which the input device can drive a graphical user interface.

In another embodiment, the mode-indicating system can include a reciprocator for alternately retracting and extending the nib. The input device can operate in a first operating mode when the nib is extended, and in a second operating mode when the nib is retracted.

The sensing system is adapted to sense indicia of a posture of the input device, including a position of the input device, with respect to the display surface. In an exemplary embodiment, the sensing system comprises a camera disposed within the input device and adapted to view the display surface.

These and other objects, features, and advantages of the present invention will become more apparent upon reading the following specification in conjunction with the accompanying drawing figures.

### BRIEF DESCRIPTION OF THE FIGURES

FIG. 1 illustrates an electronic display system, according to an exemplary embodiment of the present invention.

FIG. 2A illustrates a partial cross-sectional side view of an input device with a cap, according to an exemplary embodiment of the present invention.

FIG. 2B illustrates a partial cross-sectional side view of the input device with the cap removed, according to an exemplary embodiment of the present invention.

FIG. 3 illustrates a close-up partial cross-sectional side view of a portion of the input device, according to an exemplary embodiment of the present invention.

FIG. 4A illustrates a partial cross-sectional side view of the input device without a cap, according to an exemplary embodiment of the present invention.

FIGS. 4B-4C illustrate partial cross-sectional side views of the input device with a cap, according to exemplary embodiments of the present invention.

FIGS. 5A-5C illustrate various images of a dot pattern, as captured by a sensing device of the input device, according to an exemplary embodiment of the present invention.

FIG. 6A illustrates a partial cross-sectional side view of the input device with a nib retracted, according to an exemplary embodiment of the present invention.

FIG. 6B illustrates a partial cross-sectional side view of the input device with the nib extended, according to an exemplary embodiment of the present invention.

FIG. 7 illustrates a method of using the input device, according to an exemplary embodiment of the present invention.

### DETAILED DESCRIPTION

To facilitate an understanding of the principles and features of the invention, various illustrative embodiments are explained below. In particular, the invention is described in the context of being an electronic input device for an electronic display system. Embodiments of the invention, however, are not limited to use in electronic display systems. Rather, embodiments of the invention can be used in many electronic systems.

The components described hereinafter as making up various elements of the invention are intended to be illustrative and not restrictive. Many suitable components that would perform the same or similar functions as the components described herein are intended to be embraced within the scope of the invention. Such other components not described herein can include, but are not limited to, for example, similar components that are developed after development of the invention.

Various embodiments of the present invention comprise electronic input devices. Exemplary embodiments of the present invention can comprise a body, a nib, a mode-indicator, and a sensing system.

Referring now to the figures, wherein like reference numerals represent like parts throughout the views, the input device will be described in detail.

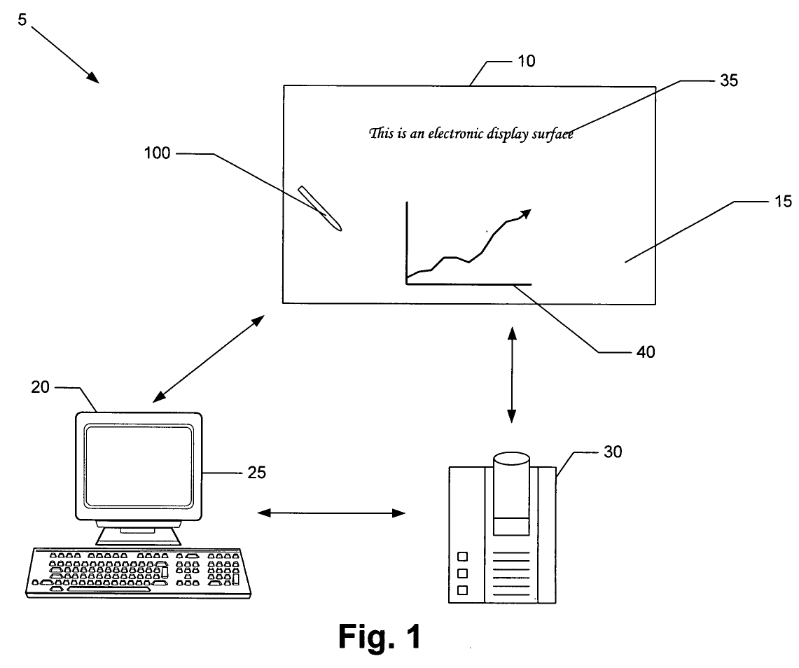

FIG. 1 illustrates an electronic display system 5, for example, an electronic whiteboard system, implementing the input device 100. The electronic display system 5 includes an electronic display device 10, such as a display board, having a display surface 15, and further includes a processing device 20 and, optionally, a projector 30.

The display device 10 is operatively connected to the processing device 20. The processing device 20 can be an integrated component of the electronic display device 10, or the processing device 20 can be an external component. Suitable processing devices include a computing device 25, such as a personal computer.

The projecting device 30, such as a conventional projector, can project one or more display images onto the display surface 15. For example and not limitation, the projector 30 can project a graphical user interface or markings created through use of the input device 100. The projecting device 30 can be in communication with the processing device 20. Such communication can be by means of a wired or wireless connection, Bluetooth, or by many other means through which two devices can communicate. Like the processing device 20, the projecting device 30 can, but need not, be integrated into the display device 10. Alternatively, the projecting device 30 can be excluded if the display device 10 is internally capable of displaying markings and other objects on its surface. For example, the display device 10 can be a computer monitor comprising a liquid crystal display.

The input device 100 can transmit a signal to the processing device 20 that operations are to be performed on the display surface 15 as indicated by the input device 100. The input device 100 can be activated by many means, such as by an actuator, such as a switch or button, or by bringing the input device 100 in proximity to the surface 15. While activated, placement or movement of the input device 100 in contact with, or in proximity to, the display surface 15 can indicate to the processing device 20 that certain operations are to occur at indicated points on the display surface 15. For example, when the input device 100 contacts the display surface 15, the input device 100 can transmit its coordinates on the display surface 15 to the processing device 20. Accordingly, the display system 5 can cause an operation to be performed on the display surface 15 at the coordinates of the input device 100. For example and not limitation, markings can be generated in the path of the input device 100, or the input device 100 can direct a cursor across the display surface 15.

Through interacting with the display surface 15, the input device 100 can generate markings on the display surface 15, which markings can be physical, digital, or both. For example, when the input device 100 moves across the display surface 15, the input device 100 can leave physical markings, such as dry-erase ink, in its path. The display surface 15 can be adapted to receive such physical markings. Additionally, movement of the input device 100 can be analyzed to create a digital version of such markings. The digital markings can be stored by the display system 5 for later recall, such as for emailing, printing, or displaying. The display surface 15 can, but need not, display the digital markings at the time of their generation, such that digital markings generally overlap the physical markings.

The complete image displayed on the display surface 15 can comprise both real ink 35 and virtual ink 40. The real ink 35 comprises the markings, physical and digital, generated by the input device 100 and other marking implements. The virtual ink 40 comprises other objects projected, or otherwise displayed, onto the display surface 15. These other objects can include, without limitation, a graphical user interface or windows of an application running on the display system 5. Real ink 35 and virtual ink 40 can overlap, and consequently, real ink 35 can be used to annotate objects in virtual ink 40.

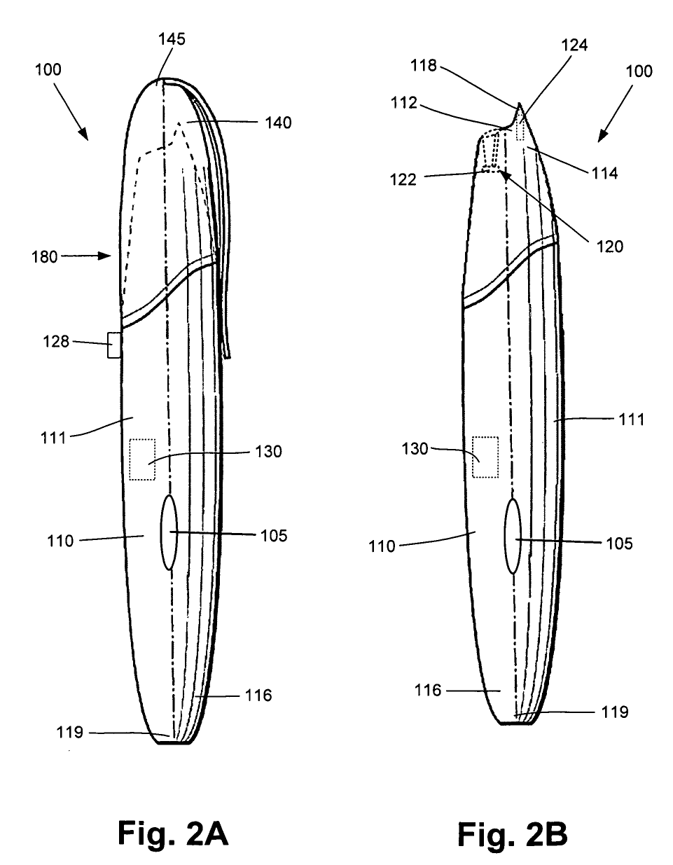

FIGS. 2A-2B illustrate partial cross-sectional side views of the input device 100. The input device 100 can comprise a body 110, a nib 118, a sensing system 120, a communication system 130, and a cap 140. Further, the input device 100 has two or more states, and each state corresponds to an operating mode of the input device 100.

The body 110 can provide structural support for the input device 100. The body 110 can comprise a shell 111, as shown, to house inner-workings of the input device 100, or alternatively, the body 110 can comprise a primarily solid member for carrying components of the input device 100. The body 110 can be composed of many materials. For example, the body 110 can be plastic, metal, resin, or a combination thereof, or many materials that provide protection to the components or the overall structure of the input device 100. The body 110 can further include a metal compartment for electrically shielding some or all of the sensitive electronic components of the device. The input device 100 can have many of shapes consistent with its use. For example, the input device 100 can have an elongated shape, similar to the shape of a conventional writing instrument, such as a pen, or a thicker design, such as a dry-erase marker.

The body 110 can comprise a first end portion 112, which is a head 114 of the body 110, and a second end portion 116, which is a tail 119 of the body 110. The head 114 is interactable with the display surface 15 during operation of the input device 100.

The nib 118 can be positioned at the tip of the head 114 of the input device 100, and can be adapted to be placed in proximity to, contact, or otherwise indicate, a point on the display surface 15. For example, as a user writes with the input device 100 on the display surface 15, the nib 118 can contact the display surface 15 as the tip of a pen would contact a piece of paper. While contact with the display surface 15 may provide for a comfortable similarity to writing with a conventional pen and paper, or whiteboard and dry-erase marker, contact of the nib 118 to the display surface 15 need not be required for operation of the input device 100. For example, once the input device 100 is activated, the user can hover the input device 100 in proximity to the display surface 15, or point from a distance, as with a laser pointer.

The nib 118 can comprise a marking tip, such as the tip of a dry-erase marker or pen. Accordingly, contact or proximity of the nib 118 to the display surface 15 can result in physical marking of the display surface 15.

The sensing system 120 is adapted to sense indicia of the posture of the input device 100. The input device 100 has six degrees of potential movement. In the two-dimensional coordinate system of the display surface 15, the input device 100 can move in the horizontal and vertical directions. The input device 100 can also move normal to the display surface 15, and can rotate about the horizontal, vertical, and normal axes. These rotations are commonly referred to, respectively, as the roll, yaw, and tilt of the input device 100. The sensing system 120 can sense many combinations of these six degrees of movement.

The term “tipping” as used herein, refers to angling of the input device 100 away from normal to the display surface 15, and, therefore, includes rotations about the horizontal and vertical axes, i.e., the roll and the yaw of the input device 100. On the other hand, “orientation,” as used herein, refers to rotation parallel to the plane of the display surface 15 and, therefore, about the normal axis, i.e., the tilt of the input device 100.

The sensing system 120 can be coupled to, and in communication with, the body 110. The sensing system 120 can have many implementations adapted to sense indicia of the posture of the input device 100 with respect to the display surface 15. For example, the sensing system 120 can sense data indicative of the distance of the input device 100 from the display surface 15, as well as the position, orientation, tipping, or a combination thereof, of the input device 100 with respect to the display surface 15.

As shown, the sensing system can include a first sensing device 122 and a second sensing device 124. Each sensing device 122 and 124 can be adapted to sense indicia of the posture of the input device 100. Further, each sensing device 122 and 124 can individually detect data for determining the posture of the input device 100 or, alternatively, can detect such data in conjunction with other components, such as another sensing device.

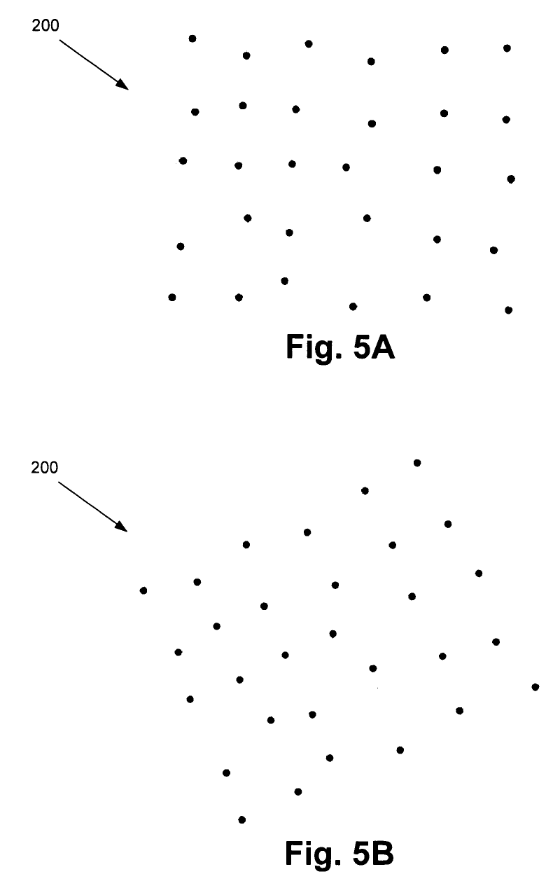

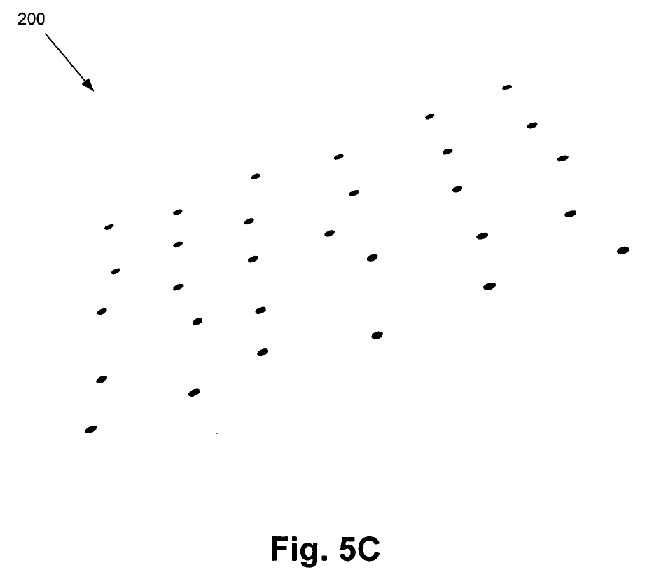

The first sensing device 122 can be a surface sensing device for sensing the posture of the input device 100 based on properties of the display surface 15. The surface sensing device 122 can be, or can comprise, a camera. The surface sensing device 122 can detect portions of a pattern 200 (see FIGS. 5A-5C) on the display surface 15, such as a dot pattern or a dot matrix position-coding pattern. Detection by the surface sensing device 122 can comprise viewing, or capturing an image of, a portion of the pattern 200.

Additionally or alternatively, the sensing system 120 can comprise an optical sensor, such as that conventionally used in an optical mouse. In that case, the sensing system 120 can comprise light-emitting diodes and photodiodes, or a CMOS camera, to detect movement relative to the display surface 15.

The surface sensing device 122 can be in communication with the body 110 of the input device 100, and can have many positions and orientations with respect to the body 110. For example, the surface sensing device 122 can be housed in the head 114, as shown. Additionally or alternatively, the surface sensing device 122 can be positioned on, or housed in, many other portions of the body 140.

The second sensing device 124 can be a contact sensor. The contact sensor 124 can sense when the input device 100 contacts a surface, such as the display surface 15. The contact sensor 124 can be in communication with the body 110 and, additionally, with the nib 118. The contact sensor 124 can comprise, for example and not limitation, a switch that closes a circuit when a portion of the input device 100, such as the nib 118 contacts a surface with predetermined pressure. Accordingly, when the input device 100 contacts the display surface 15, the display system 5 can determine that an operation is indicated.

To facilitate analysis of data sensed by the sensing system 120, the input device 100 can further include a communication system 130 adapted to transmit information to the processing device 20 and to receive information from the processing device 20. For example, if processing of sensed data is conducted by the processing device 20, the communication system 130 can transfer sensed data to the processing device 20 for such processing. The communication system 130 can comprise, for example, a transmitter, a receiver, or a transceiver. Many wired or wireless technologies can be implemented by the communication system 130. For example, the communication system 130 can implement Bluetooth or 802.11b technology.

The cap 140 can be releasably securable to the head 114 of the body 110 to cover the nib 118. The cap 140 can be adapted to protect the nib 118 and components of the input device 100 proximate the head 114, such as the surface sensing device 122.

Use of the cap 140 can result in at least two states of the input device 100. For example, the input device 100 can have a cap-on state, in which the cap 140 is secured over the nib 118, and a cap-off state, in which the cap 140 is not secured over the nib 118. The cap 140 can also be securable over the tail 119, but such securing over the tail 119 need not result in a cap-on state.

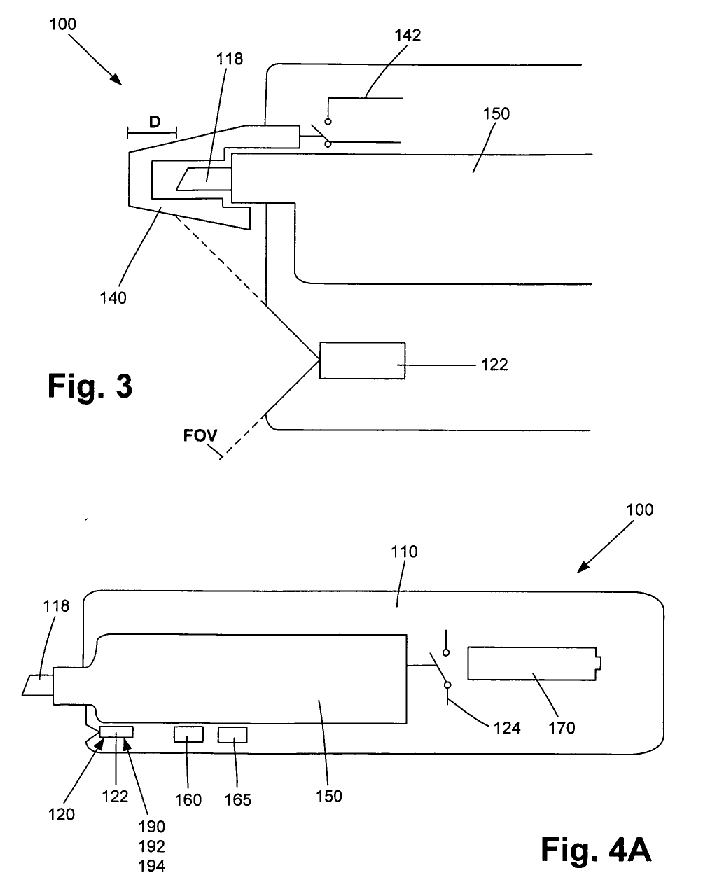

The input device 100 can detect presence of the cap 140 over the nib 118 in many ways. For instance, the cap 140 can include electrical contacts that interface with corresponding contacts on the body 110, or the cap 140 can include geometric features that engage a detente switch of the body 110. Also, presence of the cap 140 can be indicated manually or detected by a cap sensor 142 (see FIG. 3), by distance of the nib 118 from the display surface 15, or by the surface sensing device 122.

The user can manually indicate to the whiteboard system that the input device 100 is in a cap-on state. For example, the input device can comprise an actuator 105, such as a button or switch, for the user to actuate to indicate to the display system 5 that the input device 100 is acting in cap-on or, alternatively, cap-off mode.

FIG. 3 illustrates a close-up cross-sectional side view of the head 114 of the input device 100. As shown in FIG. 3, the input device 100 can comprise a cap sensor 142. The cap sensor 142 can comprise, for example, a pressure switch, such that when the cap 140 is secured over the nib 118, the switch closes a circuit, thereby indicating that the cap 140 is secured. Further, the cap sensor 142 can be a pressure sensor and can sense when the cap is on and contacting a surface, such as the display surface 15. A first degree of pressure at the cap sensor 142 can indicate presence of the cap 140 over the nib 118, while a higher degree of pressure can indicate that the cap is on and in contact with, or pressing against, a surface. The cap sensor 142 can be positioned in the body 110, as shown, or in the cap 140.

Whether the input device 100 is in cap-on mode can be further determined from the distance of the nib 118 to the display surface 15. When the cap 140 is removed, the nib is able to contact the display surface 15, but when the cap 140 is in place, the nib 118 cannot reach the display surface 15 because the cap 140 obstructs this contact. Accordingly, when the nib 118 contacts the display surface 15, it can be determined that the cap 140 is off. Further, there can exist a predetermined threshold distance D such that, when the nib 118 is within the threshold distance D from the display surface, the input device 100 is determined to be in a cap-off state. On the other hand, if the nib 118 is outside of the threshold distance D, the cap may be secured over the nib 118.

Additionally or alternatively, the surface sensing device 122 can detect the presence or absence of the cap 140 over the nib 118. When secured over the nib 118, the cap 140 can be within the range, or field of view FOV, of the surface sensing device 122. Therefore, the surface sensing device can sense the cap 140 when the cap 140 is over the nib 118, and the display system 5 can respond accordingly.

One or more states of the input device 100, such as cap-on and cap-off states, can correspond to one or more operating modes of the input device 100. Securing of the cap 140 over the nib 118 can indicate to the display system 5 that the operating mode has changed. The input device 100 can have many operating modes, including, without limitation, a marking mode and a pointing mode.

In the marking mode, the input device 100 can mark the display surface 15, digitally, physically, or both. For example, the input device 100 can be used to write or draw on the display surface 15. In the pointing mode, the input device 100 can perform in a manner similar to that of a computer mouse. The input device 100 can, for example, drive a graphical user interface, or direct a cursor about the display surface 15 to move and select displayed elements for operation. Accordingly, the input device 100 comprises a mode-indicating system 180, which incorporates the cap 140.

Referring now back to FIGS. 2A-2B, if the surface sensing device 122 is housed in, or proximate, the head 114, it is desirable that the cap 140 not obstruct sensing when the cap 140 is secured over the nib 118. To facilitate sensing of indicia of the posture of the input device 100 when the cap 140 is secured over the nib 118, the cap 140 can comprise a translucent or transparent portion 145.

Alternatively, the surface sensing device 122 can be positioned such that the display surface 15 is visible to the surface sensing device 122 regardless is whether the cap 140 is secured over the nib 118. For example, the surface sensing device 122 can be carried by the body 110 at a position not coverable by the cap 140, such as at position 128.

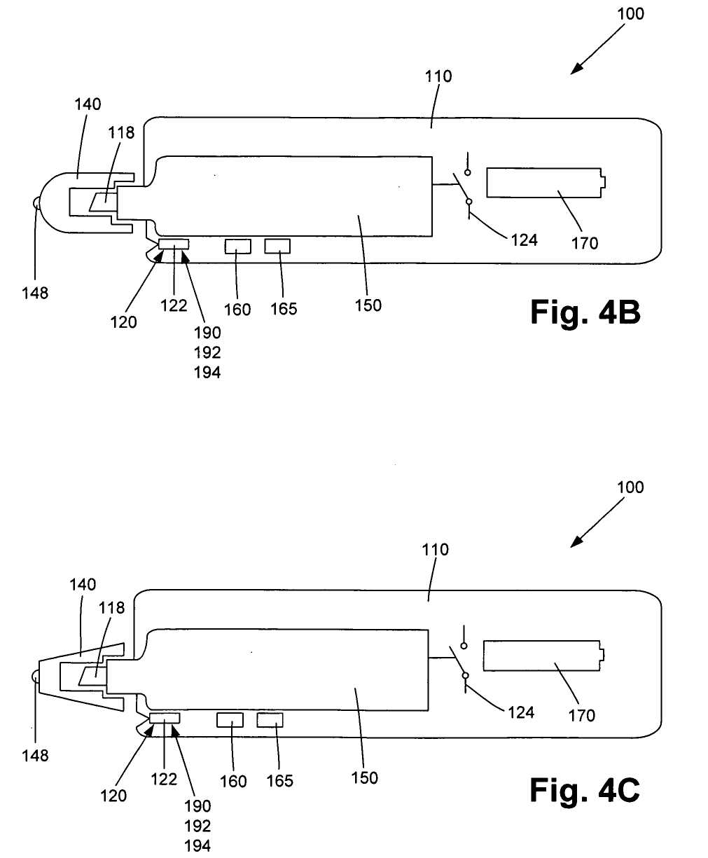

FIGS. 4A-4C illustrate another embodiment of the input device. As shown in FIG. 4A, in addition to the above features, the input device can further comprise a marking cartridge 150, an internal processing unit 160, memory 165, a power supply 170, or a combination thereof. The various components can be electrically coupled as necessary.

The marking cartridge 150 can be provided to enable the input device 100 to physically mark the display surface 15. The marking cartridge 150, or ink cartridge or ink well, can contain a removable ink, such as conventional dry-erase ink. The marking cartridge 150 can provide a comfortable, familiar medium for generating handwritten strokes on the display surface 15 while movement of the input device 100 generates digital markings.

The internal processing unit 160 can be adapted to calculate the posture of the input device 100 from data received by the sensing system 120, including determining the relative or absolute position of the input device 100 in the coordinate system of the display surface 15. The internal processing unit 160 can also execute instructions for the input device 100. The internal processing unit 160 can comprise many processors capable of performing functions associated with various aspects of the invention.

The internal processing unit 160 can process data detected by the sensing system 120. Such processing can result in determination of, for example: distance of the input device 100 from the display surface 15; position of the input device 100 in the coordinate system of the display surface 15; roll, tilt, and yaw of the input device 100 with respect to the display surface 15, and, accordingly, tipping and orientation of the input device 100.

The memory 165 can comprise RAM, ROM, or many types of memory devices adapted to store data or software for controlling the input device 100 or for processing data.

The power supply 170 can provide power to the input device 100. The power supply 170 can be incorporated into the input device 100 in any number of locations. If the power supply 170 is replaceable, such as one or more batteries, the power supply 170 is preferably positioned for easy access to facilitate removal and replacement of the power supply 170. Alternatively, the input device 100 can be coupled to alternate power supplies, such as an adapter for electrically coupling the input device 100 to a car battery, a wall outlet, a computer, or many other power supplies.

The cap 140 can comprise many shapes, such as the curved shape depicted in FIG. 4B or the faceted shape of FIG. 4C. The shape of the cap 140, however, is preferably adapted to protect the nib 118 of the input device 100.

The cap 140 can further comprise a stylus tip 148. The stylus tip 148 of the cap 140 can be interactable with the display surface 15. When the stylus tip 148 contacts or comes in proximity to the display surface 15, the input device can operate on the display surface 15, for example, by directing a cursor across the display surface 15.

Multiple caps 140 can be provided, and securing of each cap 140 over the nib 118 can result in a distinct state of the input device 100. Further, in addition to indicating a change in operating mode of the input device 100, a cap 140 can provide additional functionality to the input device 100. For example, the cap 140 can provide one or more lenses, which can alter the focal length of the surface sensing device 122. In another example, the cap 140 can be equipped with a metal tip, such as the stylus tip 148, for facilitating resistive sensing, such that the input device 100 can be used with a touch-sensitive device.

As shown, the surface sensing device 122 need not be coverable by the cap 140. Placement of the surface sensing device 122 outside of the range of the cap 140 can allow for more accurate detection of the display surface 15. Further, such placement of the surface sensing device 122 results in the cap 140 providing a lesser obstruction to the surface sensing device 122 when the cap 140 is secured over the nib 118.

Referring back to the sensing system 120, the contact sensor 124, if provided, can detect when a particular portion of the input device 100, such as the nib 118, contacts a surface, such as the display surface 15. The contact sensor 124 can be a contact switch, such that when the nib 118 contacts the display surface 15, a circuit closes, indicating that the input device 100 is in contact with the display surface 15. The contact sensor 124 can also be a force sensor, which can detect whether the input device 100 presses against the display surface 15 with a light force or a hard force. The display system 5 can react differently based on the degree of force used. If the force is below a certain threshold, the display system 5 can, for example, recognize that the input device drives a cursor. On the other hand, when the force is above a certain threshold, which can occur when the user presses the input device 100 to the board, the display system 5 can register a selection, similar to a mouse click. Further, the display system 5 can vary the width of markings generated by the input device 100 based on the degree of force with which the input device 100 contacts the display surface 15.

Additionally, the surface sensing device 122 can include, for example, a complementary metal oxide semiconductor (CMOS) image sensor, a charge-coupled device (CCD) image sensor, or many other types of sensors for receiving image information. The surface sensing device 122 can be a CMOS or CCD image-sensor array having a size of, for example, 128 by 100, 128 by 128, or larger. The sensing system 120 enables the input device 100 to generate digital markings by detecting posture and movement of the pen with respect to the display surface 15. For example and not limitation, the surface sensing device 122 can capture images of the display surface 15 as the pen is moved, and through image analysis, the display system 5 can detect the posture and movement of the input device 100.

The display surface 15 can include many types of image data indicating relative or absolute positions of the input device 100 in the coordinate system of the display surface 15. For example, the display surface 15 can comprise a known image, which can include alphanumeric characters, a coding pattern, or many discernable patterns of image data capable of indicating relative or absolute position. The implemented pattern can indicate either the position of the input device 100 relative to a previous position, or can indicate an absolute position of the input device 100 in the coordinate system of the display surface 15.

Determining a point on the display surface 15 indicated by the input device 100 can require determining the overall posture of the input device 100. The posture of the input device 100 can include the position, orientation, tipping, or a combination thereof, of the input device 100 with respect to the display surface 15. In marking mode, it may be sufficient to determine only the position of the input device 100 in the coordinate system of the display surface 15. When pointing is required, however, as in pointer mode, the orientation and tipping of the input device 100 can be required to determine the indicated point on the display surface 15.

As such, various detection systems can be provided in the input device 100 for detecting the posture of the input device 100. For example, a tipping detection system 190 can be provided in the input device 100 to detect the angle and direction at which the input device 100 is tipped with respect to the display surface 15. An orientation detection system 192 can be implemented to detect rotation of the input device 100 in the coordinate system of the display surface 15. Additionally, a distance detection system 194 can be provided to detect the distance of the input device 100 from the display surface 15.

These detection systems 190, 192, and 194 can be incorporated into the sensing system 120. For example, the position, tipping, orientation, and distance of the input device 100 with respect to the display surface 15 can be determined, respectively, by the position, skew, rotation, and size of the appearance of the pattern 200 on the display surface 15, as viewed from the surface sensing device 122. For example, FIGS. 5A-5C illustrate various views of an exemplary dot pattern 200 on the display surface 15. The dot pattern 200 serves as a position-coding pattern in the display system 5.

FIG. 5A illustrates an image of the pattern 200, which is considered a dot pattern. It is known that certain dot patterns can provide indication of an absolute position in a coordinate system of the display surface 15. In the image of FIG. 5A, the dot pattern 200 is viewed at an angle normal to the display surface 15. This is how the dot pattern 200 could appear from the surface sensing device 122, when the surface sensing device 122 is directed normal to the display surface 15. In the image, the dot pattern 200 appears in an upright orientation and not angled away from the surface sensing device 122. As such, when the surface sensing device 122 captures such an image, the display system 5 can determine that the input device 100 is normal to the display surface 15 and, therefore, points approximately directly into the display surface 15.

As the input device 100 moves away from the display surface 15, the size of the dots, as well as the distance between the dots, in the captured image decreases. Analogously, as the input device 100 moves toward the display surface 15, the size of the dots, along with the distance between the dots, appears to increase. As such, in addition to sensing the tipping and orientation of the input device 100, the surface sensing device 122 can sense the distance of the input device 100 from the display surface 15.

FIG. 5B illustrates a rotated image of the dot pattern 200. A rotated dot pattern 200 indicates that the input device 100 is rotated about a normal axis of the display surface 15. For example, when a captured image depicts the dot pattern 200 rotated at an angle of 30 degrees clockwise, it can be determined that the input device 100 is oriented at an angle of 30 degrees counter-clockwise. As with the image of FIG. 5A, this image was taken with the surface sensing device 122 oriented normal to the display surface 15, so even though the input device 100 is rotated, the input device 100 still points approximately directly into the display surface 15.

FIG. 5C illustrates a third image of the dot pattern 200 as viewed by the surface sensing device 122. The flattened image, depicting dots angled away from the surface sensing device 122, indicates that the surface sensing device 122 is not normal to the display surface 15. Further, the rotation of the dot pattern 200 indicates that the input device 100 is rotated about the normal axis of the display surface 15 as well. The image can be analyzed to determine the tipping angle and direction as well as the orientation angle. For example, it may be determined that the input device 100 is tipped downward 45 degrees, and then rotated 25 degrees. These angles determine to which point on the display surface 15 the input device 100 is directed.

Accordingly, by determining the angles at which an image received from the surface sensing device 122 was captured, the display system 5 can determine points indicated by the input device 100.

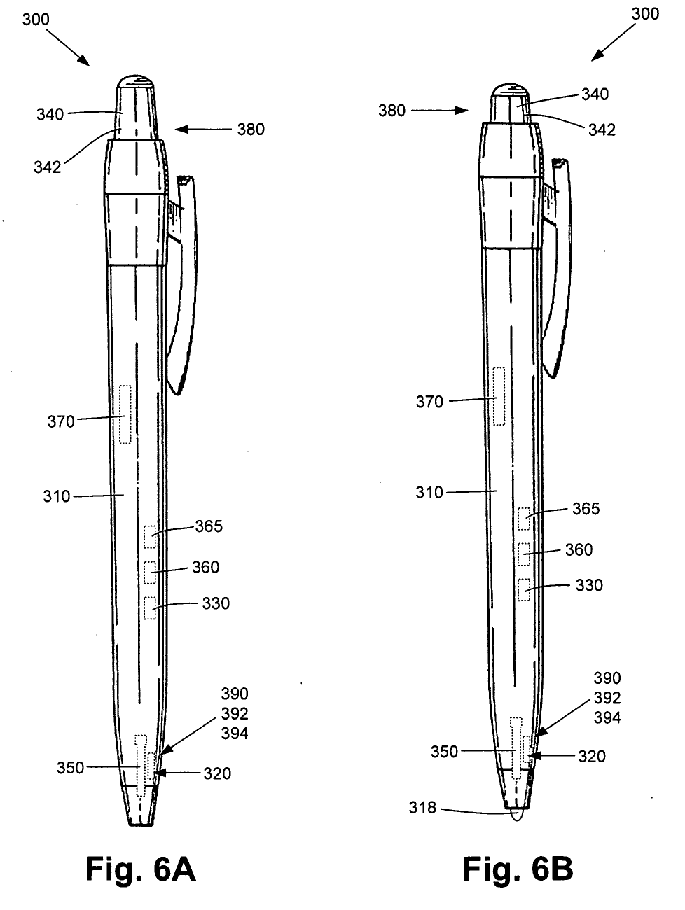

FIGS. 6A-6B illustrate partial cross-sectional side views of an embodiment of the input device 100, a retractable input device 300, implementing a retractable nib 318. FIG. 6A illustrates the retractable input device 300 with a nib 318 retracted, while FIG. 6B shows the retractable input device 300 with the nib 318 extended.

Like the embodiment of the input device 100 described above, the retractable input device 300 comprises a body 310, a nib 318, a sensing system 320, and a communication system 330, and can further comprise a marking cartridge 350, an internal processing unit 360, memory 365, a power supply 370, a tipping detection system 390, an orientation detection system 392, a distance detection system 394, or a combination thereof, all as described above.

Additionally, as shown, the retractable input device 300 can comprise a reciprocator 340. The reciprocator 340 can comprise an actuator 342, such as a button, adapted to extend and retract the nib 318. Alternate presses of the button 342 result in alternate positions of the nib 318. For example, when the button 342 is depressed a first time, as in FIG. 6B, the nib 318 extends, and when the button 342 is depressed a second time, as in FIG. 6A, the nib 318 retracts.

Like the cap 140, the reciprocator 340 can be incorporated in the mode-indicating system 380. The reciprocator 340 can define states of the retractable input device 300. For example, the retractable input device 300 can be in a retracted state or in an extended state, based on, respectively, whether the nib 318 is retracted or extended. Each state can correspond to an operating mode. For example and not limitation, when the retractable input device 300 is in the retracted state, the retractable input device 300 can operate in pointing mode. In contrast, when the retractable input device 300 is in the extended state, the retractable input device 300 can operate in marking mode. In marking mode, the nib 318 can be used as a marker and can generate both digital and physical markings.

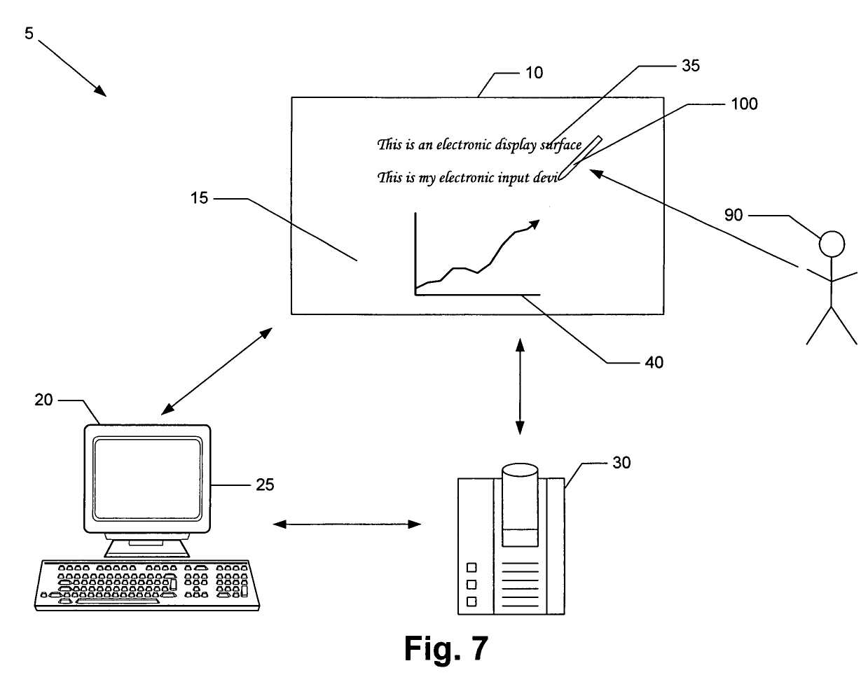

FIG. 7 illustrates a method of using the input device 100 in the display system 5. At a moment in time, the display surface 15 can display an image communicated from the processing device 20. If a projector 30 is provided, a portion of such image can be communicated from the processing device 20 to the projector 30, and then projected by the projector 30 onto the display surface 15. The display image can include real ink 35, such as physical and digital markings produced by the input device 100, as well as virtual ink 40.

In an exemplary embodiment, a user 90 can initiate further marking by bringing a portion of the input device 100 in sufficient proximity to the display surface 15, or by placing a portion of the input device 100 in contact with the display surface 15. To mark the display surface 15 in marking mode, the user 90 can move the input device 100 along the display surface 15. This movement can result in real ink 35, which can be represented digitally and physically on the display surface 15. Alternatively, in pointing mode, movement of the input device 100 along the surface 15 can result in, for example, movement of a cursor. Such movement can be similar to movement of a mouse cursor across a graphical user interface of a personal computer.

As the input device 100 travels along the display surface 15, the sensing system 120 periodically senses data indicating the changing posture of the input device 100 with respect to the display surface 15. This data is then processed by the display system 5. In one embodiment, the internal processing unit 160 of the input device 100 processes the data. In another embodiment, the data is transferred to the processing device 20 by the communication system 130 of the input device 100, and the data is then processed by the processing device 20. Processing of such data can result in determining the posture of the input device 100 and, therefore, can result in determining areas of the display surface 15 on which to operate. If processing occurs in the internal processing unit 160 of the input device 100, the results are transferred to the processing device 20 by the communication system 130.

Based on determination of relevant variables, the processing device 20 produces a revised image to be displayed onto the display surface 15. In marking mode, the revised image can incorporate a set of markings not previously displayed, but newly generated by use of the input device 100. Alternatively, the revised image can be the same as the previous image, but can appear different because of the addition of physical markings. Such physical markings, while not necessarily projected onto the display surface 15, are recorded by the processing device 20.

In pointing mode, the revised image can incorporate, for example, updated placement of the cursor. The display surface 15 is then refreshed, which can involve the processing device 20 communicating the revised image to the optional projector 30. Accordingly, operations and digital markings indicated by the input device 100 can be displayed through the electronic display system 5. In one embodiment, this occurs in real time.

While the invention has been disclosed in exemplary forms, it will be apparent to those skilled in the art that many modifications, additions, and deletions can be made without departing from the spirit and scope of the invention and its equivalents, as set forth in the following claims.

What is claimed is:

1. An input device for interacting with a display surface of an electronic display system, the input device comprising:
a body;
a nib in communication with the body;
a cap for covering the nib, the cap securable to the body over the nib, wherein the input device operates in pointer mode when the cap is secured over the nib, and in marking mode when the cap is not secured over the nib; and
a sensing system carried by the body, for sensing a position of the nib relative to the display surface.

2. The input device of claim 1, the sensing system comprising a camera for viewing a portion of the display surface.

3. The input device of claim 2, the camera adapted to view a dot pattern encoding two-dimensional coordinates on the display surface.

4. The input device of claim 3, further comprising an internal processing unit adapted to determine a position of the input device in a coordinate system of the display surface based on one or more images of the dot pattern captured by the camera.

5. The input device of claim 1, wherein the input device is adapted to generate digital markings on the display surface when the cap is not secured over the nib.

6. The input device of claim 1, wherein the input device is adapted to drive a graphical user interface when the cap is secured over the nib.

7. The input device of claim 1, further comprising a marking cartridge for marking on the display surface.

8. The input device of claim 1, further comprising a tipping detection system for detecting rotations of the input device about the horizontal and vertical axes of the display surface.

9. The input device of claim 1, further comprising an orientation detection system for detecting a rotation of the input device in a coordinate system of the display surface.

10. The input device of claim 1, further comprising a distance detection system for detecting a distance between the input device and the display surface.

11. An input device for interacting with a display surface of an electronic display system, the input device comprising:
a body;
a nib in communication with the body;
a reciprocator adapted to retract and extend the nib, wherein the input device operates in a first operating mode when the nib is extended, and in a second operating mode when the nib is retracted; and
a sensing system carried by the body, for sensing a position of the nib relative to the display surface.

12. The input device of claim 11, wherein the first operating mode is a marking mode.

13. The input device of claim 11, wherein the second operating mode is a pointing mode is a pointing mode.

14. The input device of claim 11, the sensing system comprising a camera adapted to view the display surface.

15. The input device of claim 11, further comprising an internal processing unit adapted to determine a position of the input device in a coordinate system of the display surface based on data received from the sensing system.

16. The input device of claim 11, the sensing system adapted to sense at least one of the roll, yaw, and tilt of the input device.

17. An electronic whiteboard system comprising:
a whiteboard comprising a whiteboard surface; and
an input device adapted to interact with the whiteboard surface, the input device comprising:
a body;
a nib in communication with the body;
a sensing system adapted sense a posture of the input device; and
a mode-indicating system adapted to alter an operating mode of the input device based on a state of the input device.

18. The electronic whiteboard system of claim 17, the whiteboard surface comprising a dot pattern thereon.

19. The electronic whiteboard system of 18, the sensing system of the input device comprising a camera for viewing the dot pattern on the whiteboard surface.

20. The electronic whiteboard system of claim 17, the mode-indicating system comprising a cap, wherein the input device operates in a different operating mode when the cap is secured over the nib than when the cap is not secured over the nib.

21. The electronic whiteboard system of claim 20, the operating modes comprising a marking mode and a pointing mode.

22. The electronic whiteboard system of claim 17, the mode-indicating system comprising a reciprocator for retracting and extending the nib, wherein the input device operates in a different operating mode when the nib is retracted than when the nib is extended.

23. The electronic whiteboard system of claim 22, the operating modes comprising a marking mode and a pointing mode.
